(19) United States
(12) Patent Application Publication
(10) Pub. No.: US 2011/0036556 A1
(43) Pub. Date: Feb. 17, 2011

(54) Tumble Dryer with a Heat Pump System and a Method for Controlling a Heat Pump System for a Tumble Dryer

(75) Inventors: Alberto BISON, Porcia (IT); Stefano ZANDONA', Porcia (IT); Maurizio UGEL, Porcia (IT)

Correspondence Address: BANNER & WITCOFF, LTD.;ATTORNEYS FOR CLIENT NOS. 006912 AND 026912, 1100 13th STREET, N.W., SUITE 1200, WASHINGTON, DC, 20005-4051, US

(73) Assignee: ELECTROLUX HOME PRODUCTS CORPORATION N.V., Zaventem (BE)

(21) Appl. No.: 12/855,030

(22) Filed: Aug. 12, 2010

(30) Foreign Application Priority Data
Aug. 12, 2009 (EP) 09010370.6

(51) Int. Cl. G05D 23/00; D06F 58/04; F25B 27/00; F25B 49/02

(52) U.S. Cl. 165/287; 34/108; 62/238.7; 62/228.1

(57) ABSTRACT

A tumble dryer with at least one heat pump system has an air stream circuit (10) including at least one drum (12) for receiving laundry to be dried, at least one refrigerant circuit (14) including at least one compressor (16) with a variable rotation speed, a first heat exchanger (18) for a thermal coupling between the air stream circuit (10) and the refrigerant circuit (14), and a second heat exchanger (20) for a further thermal coupling between the air stream circuit (10) and the refrigerant circuit (14). The tumble dryer further includes a control unit (22) for controlling the rotation speed of the compressor (16) and at least one sensor for detecting at least one physical parameter (TDI, TDO; TEI, TEO; TF; Z; RH) as function of the time of the air stream, the refrigerant ad/or the laundry. A central processing unit is provided, which is arranged to evaluate the time development of the physical parameter (TDI, TDO, TEI, TEO; TF; Z; RH) and which reduces the rotation speed of the compressor (16) according to the evaluation of the time development of the physical parameter (TDI, TDO, TEI, TEO; TF; Z; RH). A corresponding method for controlling a heat pump system for a tumble dryer is also set forth.

### CROSS-REFERENCE TO RELATED APPLICATION

This application claims priority under 35 U.S.C. §119 to European application EP 09010370.6, filed Aug. 12, 2009.

### BACKGROUND OF THE INVENTION

The present invention relates to a tumble dryer with a heat pump system. Further, the present invention relates to method for controlling a heat pump system.

For a tumble dryer, the heat pump technology is a very efficient way to save energy. A usual tumble dryer with heat pump technology uses a reciprocating fixed speed compressor for the refrigerant circuit. This type of compressor has several disadvantages. The design of the compressor is very complex. This compressor is very big and needs a large space. Such a compressor works in an on/off-mode, so that the operating parameters of said compressor cannot be controlled during the operation.

DE 10 2005 041 145 A1 discloses a tumble dryer with a heat pump system. The refrigerant circuit of said heat pump system includes a compressor with a variable power output. The power output of the compressor depends either on detected parameters or on a predetermined scheme.

### SUMMARY OF SELECTED INVENTIVE ASPECTS

It is an object of the present invention to provide a tumble dryer with a heat pump system and a method for controlling a heat pump system for a tumble dryer, which allow an additional saving of energy.

The above-stated object of the present invention may be achieved by a tumble dryer as described herein.

According to an aspect of the present invention, a central processing unit is provided, which is arranged to evaluate the time development of a physical parameter, and which reduces the rotation speed of a compressor according to the evaluation of the time development of the physical parameter. A control unit for controlling the rotation speed of the compressor can be part of the central processing unit.

A physical parameter is selected whose time development is an indicator for the time development of the dryness of the laundry. Thus, the evaluation of its time development allows to detect an increasing dryness of the laundry, and according to the increasing dryness, the rotation speed of the compressor is reduced, e.g. continuously or gradually or in one or more steps.

A main idea of an aspect of the present invention is the reduction of the rotation speed of the compressor when the water content in the laundry decreases. The time development of one or more physical parameters corresponding with the dryness of the laundry is a suitable and efficient criterion for controlling the rotation speed of the compressor. Often the values of such physical parameters change abruptly, when the laundry becomes drier. Thus, the increasing dryness of the laundry is recognized by means of said physical parameters and the rotation speed of the compressor can be reduced. The reduced rotation speed of the compressor is sufficient and saves energy, since the excess of energy could not be used and would be lost. That phase of the drying procedure, in which the water content of the laundry is clearly reduced, is referred as a residual drying phase.

According to a preferred embodiment of the present invention, a first heat exchanger is formed as a condenser of the heat pump system and a second heat exchanger is formed as an evaporator of the heat pump system.

For example, the physical parameter is the difference between the temperature of the air stream at the drum inlet of the air stream and the temperature of the air stream at the drum outlet of the air stream. The difference between the temperature at the drum inlet and the temperature at the drum outlet decreases with the increasing dryness of the laundry.

Alternatively, or additionally, the physical parameter may be the temperature of the air stream at the air outlet of the second heat exchanger. The temperature at the air outlet of the second heat exchanger also decreases with the increasing dryness of the laundry.

Further, the physical parameter may be the difference between the temperature of the air stream at the air inlet of the second heat exchanger (which is identical or at least comparable to the temperature of the air stream at the drum outlet for the air stream, thus, this temperature could also be used) and the temperature at the air outlet of the second heat exchanger. The difference between the temperature at the air inlet and the temperature at the air outlet of the second heat exchanger increases with the increasing dryness of the laundry.

According to another embodiment of the present invention, the physical parameter is the electrical impedance of the laundry within the drum. The electrical impedance of laundry within the drum increases with the increasing dryness of the laundry.

According to a further embodiment of the present invention, the physical parameter is the temperature of the refrigerant in the refrigerant outlet of the second heat exchanger. Said temperature decreases with the increasing dryness of the laundry.

Further, the physical parameter may be the relative humidity of the drying air within the drum. The relative humidity of the drying air within the drum decreases with the increasing dryness of the laundry.

In particular, at least one sensor for detecting the relative humidity of the drying air may be arranged within the drum and/or at the drum outlet.

The aforementioned object of the present invention may be further achieved by a method for controlling a heat pump system for a tumble dryer.

According to an aspect of the present invention, a method is provided for a tumble dryer with at least one heat pump system comprising an air stream circuit including at least one drum for receiving laundry to be dried, at least one refrigerant circuit including at least one compressor with a variable rotation speed, a first heat exchanger for a thermal coupling between the air stream circuit and the refrigerant circuit and a second heat exchanger for a further thermal coupling between the air stream circuit and the refrigerant circuit. In particular, the method may be applied to a tumble dryer according to the invention, as described above.

A method according to an aspect of the invention comprises the following steps:
detecting at least one physical parameter of the air stream, the refrigerant and/or the laundry, as a function of the time,
evaluating the time development of the physical parameter, and
reducing the rotation speed of the compressor according to the evaluation of the time development of the physical parameter.

A physical parameter may be selected whose time development is an indicator for the time development of the dryness of the laundry. Thus, the evaluation of its time development allows detection of an increasing dryness of the laundry, and according to the increasing dryness, the rotation speed of the compressor is reduced, e.g. continuously or gradually or in one or more steps.

A main idea of an aspect of the inventive method is the reduction of the rotation speed of the compressor when the water content in the laundry decreases. The time development of one or more physical parameters corresponding with the dryness of the laundry is a suitable and efficient criterion for controlling the rotation speed of the compressor. Often such kinds of physical parameters are changed abruptly, when the laundry becomes drier. Thus, the increasing dryness of the laundry is recognized by means of said physical parameters and the rotation speed of the compressor is reduced. The reduced rotation speed of the compressor is sufficient for the further drying procedure and saves energy, since the excess of additional energy could not be used and would be lost.

For example, the physical parameter is the difference between the temperature of the air stream at the drum inlet of the air stream and the temperature of the air steam at the drum outlet of the air stream, which difference decreases with the increasing dryness of the laundry.

Alternatively or additionally, the physical parameter may be the temperature of the air stream at the air outlet of the second heat exchanger, which temperature also decreases with the increasing dryness of the laundry.

According to another embodiment of the present invention, the physical parameter may be the difference between the temperature of the air stream at an air inlet of the second heat exchanger and the temperature of the air stream at the air outlet of the second heat exchanger, which difference increases with the increasing dryness of the laundry.

Further, the physical parameter may be the electrical impedance of the laundry within the drum, which electrical impedance increases with the increasing dryness of the laundry.

According to a further embodiment of the present invention the physical parameter is the temperature of the refrigerant in the refrigerant outlet of the second heat exchanger, which temperature decreases with the increasing dryness of the laundry.

In a preferred embodiment, the method according to the present invention provides for a reduction of rotation speed of the compressor after a delay time interval (DTI) has elapsed from the detection of the maximum temperature value of the refrigerant at evaporator outlet.

Further, the physical parameter may be the relative humidity of the drying air within the drum. The relative humidity of the drying air within the drum decreases with the increasing dryness of the laundry.

In particular, in one embodiment, at least one sensor for detecting the relative humidity of the drying air is arranged within the drum and/or at the drum outlet.

### BRIEF DESCRIPTION OF THE DRAWINGS

The invention will be described in further detail with reference to the drawings, in which:

FIG. 1 illustrates a schematic diagram of a tumble dryer with a heat pump system according to a preferred embodiment of the present invention.

FIG. 2 illustrates a schematic diagram of the temperature of the air stream at the drum inlet of the air stream, the temperature of the air stream at the drum outlet of the air stream and the temperature at the air outlet of the second heat exchanger (e.g. an evaporator) as functions of the time according to a preferred embodiment of the present invention.

FIG. 3 illustrates a schematic diagram of the difference between the temperature of the air stream at the air inlet and the temperature at the air outlet of the second heat exchanger (e.g. an evaporator) as a function of the time according to a preferred embodiment of the present invention.

FIG. 4 illustrates a schematic diagram of a difference between the temperature of the air stream at the drum inlet of the air stream and the temperature of the air stream at the drum outlet of the air stream as a function of the time according to a preferred embodiment of the present invention.

FIG. 5 illustrates a schematic diagram of the temperature of the air stream at the air inlet of the second heat exchanger (e.g. an evaporator) and the temperature of the air stream at the air outlet of the second heat exchanger as functions of the time according to a preferred embodiment of the present invention.

FIG. 6 illustrates a schematic diagram of an electrical impedance of the laundry in a drum as function of the time t according to a further embodiment of the present invention.

FIG. 7 illustrates a schematic diagram of the temperature of the air stream at the drum inlet for the air stream, the temperature of the air stream at the drum outlet for the air stream and the refrigerant temperature at the refrigerant outlet of the second heat exchanger (e.g. an evaporator) as functions of the time according to a further embodiment of the present invention.

FIG. 8 illustrates a schematic diagram of the relative humidity of the air stream at the drum outlet for the air stream as function of the time according to a further embodiment of the present invention.

### DETAILED DESCRIPTION OF EXAMPLE EMBODIMENTS

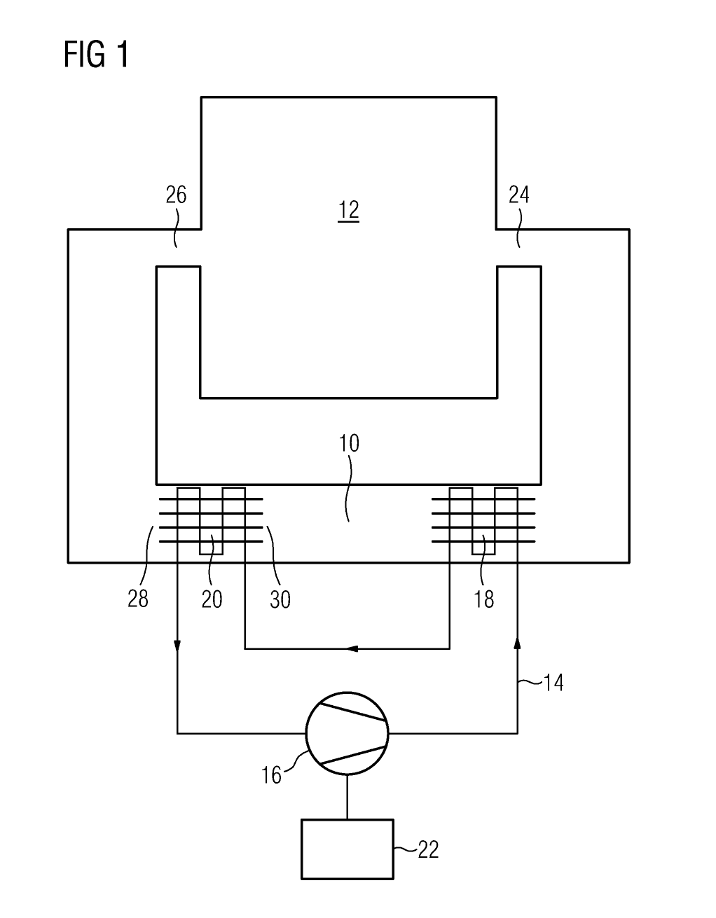

FIG. 1 illustrates a schematic diagram of a tumble dryer with a heat pump system according to a preferred embodiment of the present invention. In FIG. 1, only the substantial components of the tumble dryer with the heat pump system are shown. The tumble dryer with a heat pump system comprises an air stream circuit 10, a drum 12, a refrigerant circuit 14, a compressor 16, a first heat exchanger 18, a second heat exchanger 20 and a control unit 22.

The drum 12 is an integrated part of the air stream circuit 10. The drum 12 is provided for receiving laundry. In a similar way, the compressor 16 is an integrated part of the refrigerant circuit 14. The air stream circuit 10 and the refrigerant circuit 14 are thermally coupled by the first heat exchanger 18 and the second heat exchanger 20. The first heat exchanger works as a condenser 18. The second heat exchanger works as an evaporator 20. The control unit 22 is provided for controlling the compressor 16. In particular, the control unit 22 is provided for controlling the rotation speed of the compressor 16.

Further, the tumble dryer may comprise several kinds of sensor elements, which are not shown in FIG. 1. For example, the sensor elements may be provided for detecting the temperature, the relative humidity and/or the electrical impedance at suitable positions of the tumble dryer. In particular, the sensor elements for detecting the temperature of the air stream may be arranged at a drum air inlet 24, at a drum air outlet 26, at an evaporator air inlet 28 and/or at an evaporator air outlet 30.

In the air stream circuit 10, the air stream is generated by at least one fan, which is not shown in FIG. 1. For example, the fan may be arranged at or in the environment of a drum air inlet 24. In FIG. 1 the air stream circulates counter-clockwise in the air stream circuit 10. In this example, the air stream circuit 10 is a closed circuit.

A refrigerant flows in the refrigerant circuit 14. In FIG. 1 the refrigerant flows counter-clockwise in the refrigerant circuit 14. The refrigerant is compressed and heated by the compressor 16. The heated refrigerant reaches the condenser 18. In the condenser 18 the air stream is heated and the refrigerant is condensed and cooled down. Between the condenser 18 and the evaporator 20 the refrigerant is cooled down and preferably expanded by suitable means, which are not shown in FIG. 1. In the evaporator 20 the air stream is cooled down and the refrigerant is warmed up.

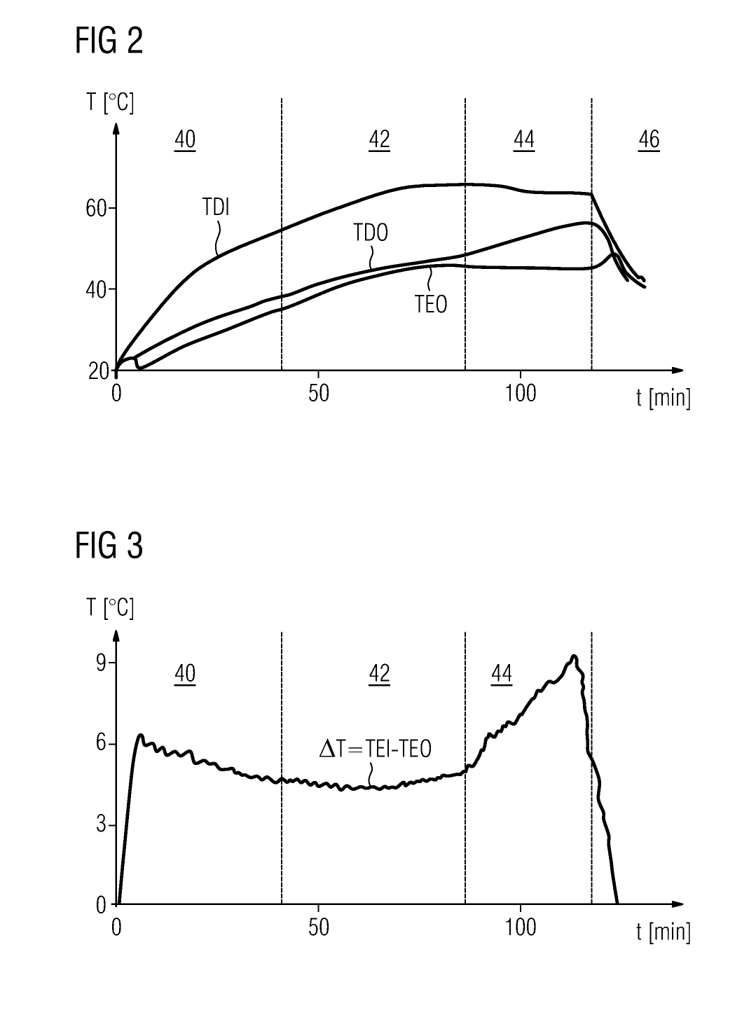

FIG. 2 illustrates a schematic diagram of a temperature TDI at the drum air inlet 24, a temperature TDO at the drum air outlet 26 and a temperature TEO at the evaporator air outlet 30 as a function of the time t. FIG. 2 clarifies that the dry process can be subdivided into four phases 40, 42, 44 and 46.

During a warm up phase 40, the temperatures TDI, TDO and TEO increase. At the end of the warm up phase 40 the temperature TDI at the drum inlet 11 is plainly higher than the temperature TDO and TEO at the drum outlet 11 and evaporator out-let 11, respectively. The temperature TDO at the drum outlet 11 and the temperature TEO at the evaporator outlet 11 remain substantially within the same order of magnitude at the end of the warm up phase 40.

During a main drying phase 42, the differences between the temperature TDI on the one hand and the temperatures TDO and TEO on the other hand are substantially maintained. In the main drying phase 42 all the temperatures TDI, TDO and TEO increase slowly.

During a residual drying phase 44, the temperatures TDI and TEO remain substantially constant, while the temperature TDO increases in a relevant way. In the residual drying phase 44 the moisture of the laundry in the drum 12 is reduced, since the energy introduced into the drum 12 by the air stream is not completely used for extracting the water from the laundry. Thus, the unused energy causes the increase of temperature in the air stream.

During a cooling phase 46, the temperatures TDI, TDO and TEO reach at last their original values.

The temperature difference between TDI and TDO in the main drying phase 42 is about 20° C. This means that a huge part of the heat carried by the air stream is effectively used to extract the water from the laundry. However, this does not happen in the subsequent residual drying phase 44, in which the temperature difference between TDI and TDO sinks down to about 5° C. The air stream does not exchange such an amount of heat with the water in the laundry and keeps most of its energy content, which results in the increased temperature TDO. This energy cannot be used and is effectively lost.

The decreasing temperature difference between TDI and TDO could also be considered as an increasing temperature difference between TDO and TEO. Both temperature differences can be used as parameters for controlling the drying process. In particular, the flow rate of the refrigerant circuit 14 can be controlled by setting up the rotation speed of the compressor 16.

The rotation speed of the compressor 16 can be controlled in dependence of the temperature of the air stream. During the warm up phase 40, the rotation speed of the compressor 16 is usually set at its maximum value in order to speed up the heating up of the refrigerant circuit 14.

During the main drying phase 42 different concepts for controlling the rotation speed of the compressor 16 can be used in order to privilege the drying time or the energy consumption. In the main drying phase 42 the temperature difference between TDI and TDO remains almost constant.

The beginning of the residual drying phase 44, in which the temperature difference between TDI and TDO decreases rapidly, can be identified by the detected temperature TDO or by the detected temperature difference between TDO on the one hand and TDI or TEO on the other hand. At the beginning of the residual drying phase 44, the rotation speed of the compressor 16 is reduced in order to decrease the energy given to the air stream circuit 10. Thus, only that energy, which can really be used for drying the last part of the laundry, is input to the air stream circuit 10.

In particular, the following detected or detectable parameters can be used for control-ling the rotation speed of the compressor 16:

the temperature TDO at the drum air outlet 26,
the difference between the temperature TDI at the drum air inlet 24 and the temperature TDO at the drum air outlet 26, or
the difference between the temperature TDO at the drum air outlet 24 and the temperature TEO at the evaporator outlet 26.

The aforementioned differences between TDI and TDO or between TDO and TEO, respectively, are more precise, since the beginning of the residual drying phase 44 is more clearly recognizable.

FIG. 3 illustrates a schematic diagram of a difference ΔT between the temperature TEI of the air stream at the evaporator air inlet 28 and the temperature TEO of the air stream at the evaporator air outlet 30 as a function of the time t according to a preferred embodiment of the present invention.

The difference ΔT between the temperature TEI at the evaporator air inlet 28 and the temperature TEO at the evaporator air outlet 30 during the warm up phase 40 and particularly during the main drying phase 42 do not show any extraordinary behaviour. However, the difference between the temperatures TEI and TEO increases rapidly during the residual drying phase 44.

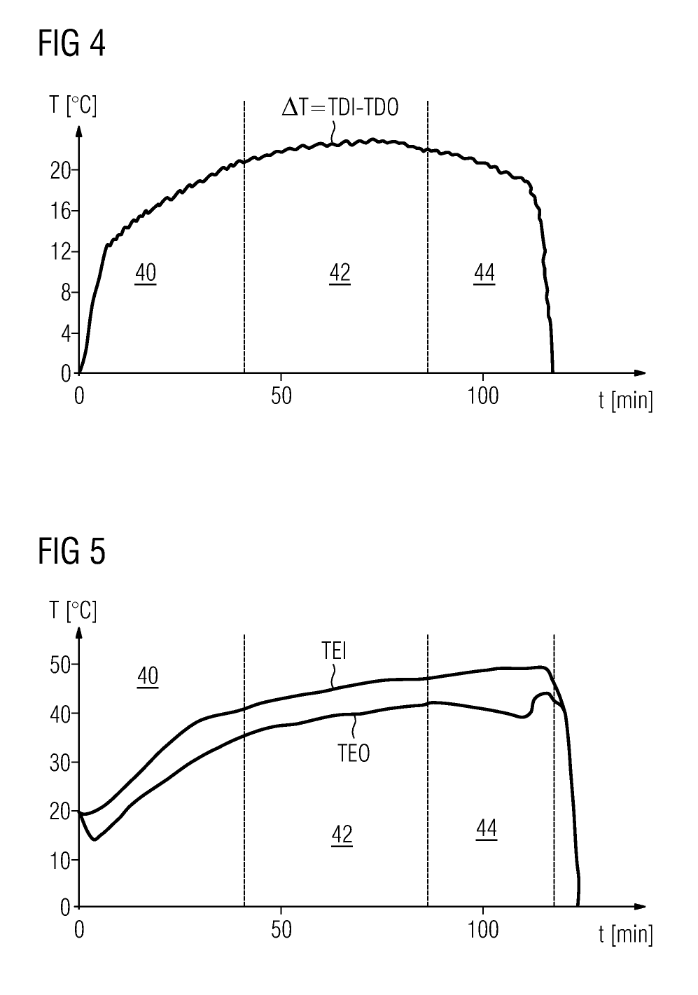

FIG. 4 illustrates a schematic diagram of a difference ΔT between the temperature TDI of the air stream at the drum air inlet 24 and the temperature TDO of the air stream at the drum air outlet 26 as a function of the time t according to a preferred embodiment of the present invention.

The difference ΔT between the temperature TDI at the drum inlet 24 and the temperature TDO at the drum outlet 26 as function of the time t is substantially constant during the main drying phase 42 and decreases in the residual drying phase 44.

FIG. 5 illustrates a schematic diagram of the temperature TEI of the air stream at the evaporator air inlet 28 and the temperature TEO of the air stream at the evaporator air outlet 30 as functions of the time t according to a preferred embodiment of the present invention.

The temperature TEI at the evaporator air inlet 28, as function of the time t, substantially increases during the main drying phase 42 and the residual drying phase 44. However, the temperature TEO at the evaporator air outlet 30 as function of the time t increases during the main drying phase 42 and decreases in the residual drying phase 44.

Thus, the functions shown in FIG. 3, FIG. 4 and FIG. 5 are suitable to recognize the beginning of the residual drying phase 44. The detection of the corresponding values of these temperatures and differences of temperatures as function of the time t allows the identification of the residual drying phase 44.

Such diagrams of temperatures or differences of temperatures as a function of the time t may be kept as a feedback reference to introduce always the optimum energy level by recognizing the beginning of the residual drying phase 44 and changing the rotation speed of the compressor 16.

Further, a minimum value for the rotation speed of the compressor 16 can be set over the rotation speed range of the compressor 16.

The aim of controlling the rotation speed of the compressor 16 is to avoid fluctuations of the temperatures and of the differences of temperatures. Said temperatures, and the differences of temperatures, should be kept constant as much as possible. The control of the rotation speed of the compressor 16 allows, during the residual drying phase 44, the same or a similar developing of the temperatures and differences of temperatures as in the main drying phase 42.

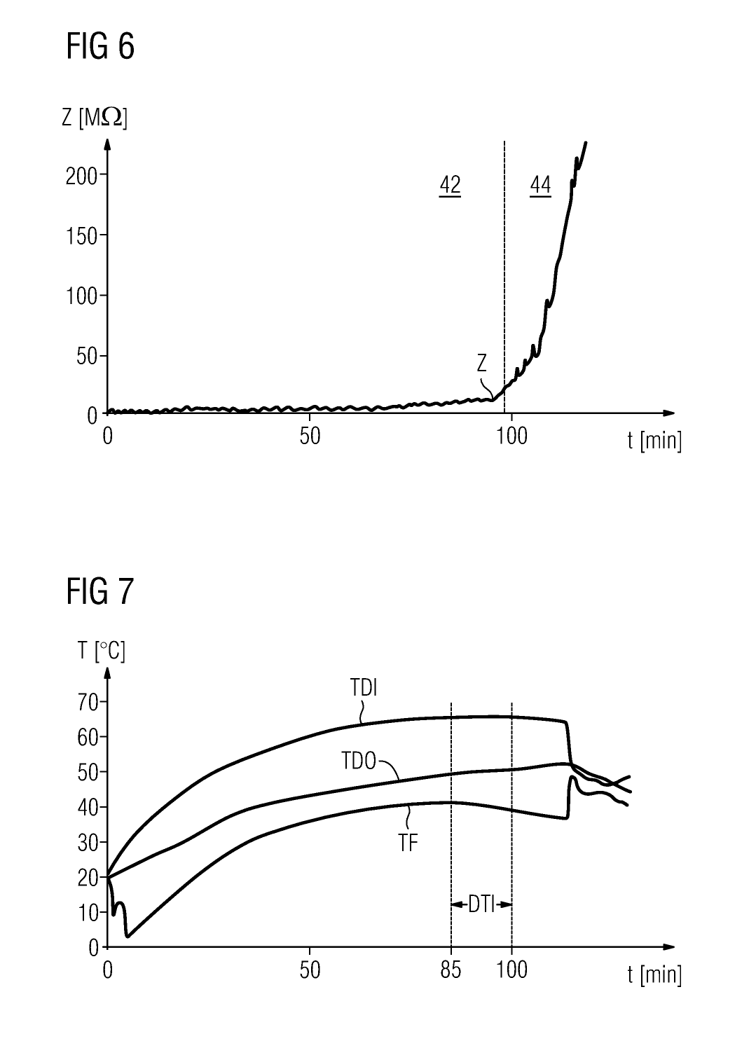

FIG. 6 illustrates a schematic diagram of an electrical impedance Z of the laundry in the drum 12 as a function of the time t according to a further embodiment of the pre-sent invention. The proper electrical impedance is a function oscillating with big amplitudes at high frequencies. The electrical impedance Z shown in FIG. 6 is a filtered function of said proper impedance.

There is only a slowly increasing electrical impedance Z in the main drying phase 42. However, during the residual drying phase 44, the electrical impedance Z increases rapidly. The electrical impedance Z of the laundry provides a further way to recognize the beginning of the residual drying phase 44.

In this case, the tumble dryer may have a set of electrodes within the drum 12 or at the drum inlet 24 or drum outlet 26, in order to detect the conductivity and/or the resistance of the laundry inside the drum 12. The conductivity and the resistance of the laundry are a property depending on the dryness of the laundry. The electrical impedance Z of the laundry is always increasing during the drying procedure. In practice, the laundry closes an electrical circuit comprising different metallic sensors contacting the clothes and electrically insulated one from the other such as different portions of the metallic drum, metallic part of the lifters and parts of the drum, different parts of the lifters, electrodes adapted to contact the laundry arranged at the clothes loading/unloading opening and portions of the drum and different electrodes.

FIG. 7 illustrates a schematic diagram of the temperature TDI at the drum air inlet 24, the temperature TDO at the drum air outlet 26 and a refrigerant temperature TF at the refrigerant outlet of the evaporator 20 as functions of the time t according to a further embodiment of the present invention.

The refrigerant temperature TF at the refrigerant outlet of the evaporator 20 as a function of the time t is similar to the function of the temperature TEO of the air stream at the evaporator air outlet 30 in FIG. 2. However, some differences exist in correspondence of the beginning of the residual drying phase 44, since it has been noted that the trend over time of the refrigerant temperature TF changes earlier with respect to the detected starting point of the decreasing of the temperature difference between TDI and TDO. In particular it has been noted that the refrigerant temperature TF at the refrigerant outlet of the evaporator 20 starts to decrease earlier than the beginning of the decreasing of temperature difference between TDI and TDO. In other words the residual drying phase 44 begins after the refrigerant has reached its maximum temperature value during the drying cycle.

In detail, the refrigerant temperature TF tends to increase after the drying cycle has been started due to the thermal load of the evaporation water that releases heat to the refrigerant thereby causing the latter to became gas and at the same time superheating the part of the refrigerant already in gas phase. When the thermal load associated with the air in the evaporator 20 decreases, i.e. there is not enough water since the laundry is becoming less and less wet, the heat released is not sufficient to keep superheating the refrigerant so that the refrigerant temperature tends to decrease after having reached a maximum value. It has been noted that the beginning of the residual drying phase 44, in which the temperature difference between TDI and TDO starts to de-crease, occurs after a Delay Time Interval DTI has elapsed from the moment in which the refrigerant temperature TF tends to decrease (after the maximum value has been reached).

FIG. 7 clarifies that the change from the positive slope to the negative slope of the refrigerant temperature TF correlates with the beginning of the residual drying phase 44. It is to be noted that the part of curves depicted in FIG. 7 on the right where the TDI abruptly drops and the TF suddenly increases refers to the cooling phase 46 (similarly to FIG. 2) when the compressor is deactivated.

FIG. 7 shows further that the difference between the temperature TDI at the drum air inlet 24 and the temperature TDO at the drum air outlet 26 decreases later than the change from the positive slope to the negative slope of the refrigerant temperature TF. In practise the difference between the temperature TDI at the drum air inlet 24 and the temperature TDO at the drum air outlet 26 decreases with a Delay Time Interval DTI with respect to the moment in which the refrigerant temperature TF has reached the maximum value during the drying cycle.

Hence, an embodiment of a method according to the present invention provides that the reduction of the rotation speed of the compressor is preferably performed after a Delay Time Interval DTI has elapsed from the detection, during the drying cycle, of the temperature maximum value of the refrigerant at the outlet of the evaporator 20.

An accurate data analysis on different tumble dryers with the variable speed compressor at different levels of input power has shown that a double filtering process may give a feedback signal, in which the time difference between the result of the evaluation of the refrigerant temperature TF and the result of the evaluation of the air stream temperature difference mentioned above is very similar, and allows to make the two signals and their evaluation correspond. Said double filtering process is performed two times by a first order filter with the same time constant. Thus, it is possible to de-fine a common control logic for the reduction of the rotation speed of the compressor 16. It is clear that alternative filtering process can be employed to achieve similar results, for example a single filtering process with an appropriate time constant or any other filtering processes of common techniques.

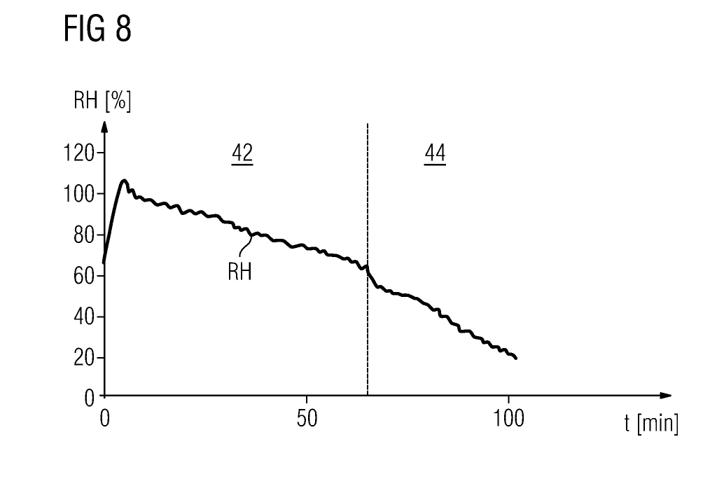

FIG. 8 illustrates a schematic diagram of the relative humidity RH of the air stream at the drum air outlet 26 as a function of the time t according to a further embodiment of the present invention. The relative humidity RH of the air stream within the drum 12 decreases when the laundry becomes dry. Since the behaviour of the relative humidity RH is repeatable, the residual drying phase 44 can be recognized.

According to FIG. 8, the relative humidity RH starts with a high value and decreases slowly during the main drying phase 42. In the residual drying phase 44 the relative humidity RH decreases more rapidly. Thus, the beginning of the residual drying phase 44 can be recognized by the development of the relative humidity RH. When the rotation speed of the compressor 16 is reduced after the beginning of the residual drying phase 44, then only that energy is input to the air stream circuit 10, which can be really used.

The above physical parameters as functions of the time are suitable to recognize the beginning of the residual drying phase 44. Then, the rotation speed of the compressor 16 is reduced, so that energy can be saved.

In a further embodiment of the present invention, weighting sensor means are pro-vided to determine the amount of the laundry (e.g., clothes) loaded inside the drum and in response to said detection the control unit adjusts the rotation speed of the compressor accordingly. For example, in the case of a half-load detected by the weighting sensor means with respect to the full-load capacity of the drum, the control unit is adapted to decrease the rotation speed of the compressor when compared to the rotation speed used for a full-load cycle. As an alternative or in addition, the data relating to the amount of the clothes can be inputted directly or selected by the user into the control unit at the control panel, and in particular a half-load drying cycle can be selectable.

Additionally, or in alternative to the above, the weighting sensor means are adapted to detect the decreasing of the weight of the clothes due to the water evaporation during the drying cycle and to transmit the data relating to the weight variation to the control unit which in turn adjusts the rotation speed of the compressor so that the rotation speed decreases while the clothes weight decreases.

In other words, according to the present invention, the method for controlling a variable rotation speed compressor comprises detecting the decreasing of the weight of the clothes due to the water evaporation during the drying cycle, and in response to the weight variation, controlling the rotation speed of the compressor so that the rotation speed decreases while the clothes weight decreases.

Although an illustrative embodiment of the present invention has been described herein with reference to the accompanying drawings, it is to be understood that the present invention is not limited to those precise embodiments, and that various other changes and modifications may be affected therein by one skilled in the art without departing from the scope or spirit of the invention. All such changes and modifications are intended to be included within the scope of the invention as defined by the appended claims.

### LIST OF REFERENCE NUMERALS AND SYMBOLS

10 air stream circuit
12 drum
14 refrigerant circuit
16 compressor
18 first heat exchanger, condenser
20 second heat exchanger, evaporator
21 control unit
22 drum air inlet
24 drum air outlet
26 evaporator air inlet
28 evaporator air outlet
30 warm up phase
40 main drying phase
42 residual drying phase
44 cooling phase
t time
TDI temperature at the drum inlet
TDO temperature at the drum outlet
TEI temperature at the evaporator inlet
TEO temperature at the evaporator outlet
TF refrigerant temperature at the evaporator outlet
ΔT difference between two temperatures
Z electrical impedance of the laundry
RH relative humidity

1. A tumble dryer with at least one heat pump system, which tumble dryer comprises:
an air stream circuit including at least one drum for receiving laundry to be dried,
at least one refrigerant circuit including at least one compressor with a variable rotation speed,
a first heat exchanger for a thermal coupling between the air stream circuit and the refrigerant circuit,
a second heat exchanger for a further thermal coupling between the air stream circuit and the refrigerant circuit,
a control unit for controlling the rotation speed of the compressor, and
at least one sensor for detecting at least one physical parameter of the air stream, the refrigerant and/or the laundry as a function of the time, wherein
a central processing unit is provided, which is arranged to evaluate the time development of the at least one physical parameter and which reduces the rotation speed of the compressor according to the evaluation of the time development of the at least one physical parameter.

2. The tumble dryer according to claim 1, wherein the first heat exchanger is formed as a condenser of the heat pump system and the second heat exchanger is formed as an evaporator of the heat pump system.

3. The tumble dryer according to claim 1, wherein the at least one physical parameter comprises a difference between a temperature of the air stream at a drum inlet of the air stream and a temperature of the air stream at a drum outlet of the air stream.

4. The tumble dryer according to claim 1, wherein the at least one physical parameter comprises a difference between a temperature of the air stream at an air inlet of the second heat exchanger and a temperature of the air stream at an air outlet of the second heat exchanger.

5. The tumble dryer according to claim 1, wherein the at least one physical parameter comprises an electrical impedance of the laundry within the drum.

6. The tumble dryer according to claim 1, wherein the at least one physical parameter comprises a temperature of the refrigerant in a refrigerant outlet of the second heat exchanger.

7. The tumble dryer according to claim 1, wherein the at least one physical parameter comprises a relative humidity of drying air within the drum, and wherein at least one sensor for detecting the relative humidity of the drying air is arranged within the drum and/or at a drum outlet.

8. The tumble dryer according to claim 1, wherein a weighting sensor is provided to detect the decreasing of the weight of laundry due to water evaporation during a drying cycle, and in response to the weight variation said control unit is adapted to adjust the rotation speed of the compressor so that the rotation speed decreases while the laundry weight decreases.

9. A method for controlling a tumble dryer with at least one heat pump system, said system comprising an air stream circuit including at least one drum for receiving laundry to be dried, at least one refrigerant circuit including at least one compressor with a variable rotation speed, a first heat exchanger for a thermal coupling between the air stream circuit and the refrigerant circuit and a second heat exchanger for a further thermal coupling between the air stream circuit and the refrigerant circuit, said method comprising:
detecting at least one physical parameter of an air stream, a refrigerant and/or laundry as a function of time,
evaluating the time development of the physical parameter, and
reducing the rotation speed of the at least one compressor according to the evaluation of the time development of the at least one physical parameter.

10. The method according to claim 9, wherein the at least one physical parameter comprises a difference between a temperature of the air stream at a drum inlet and a temperature of the air stream at a drum outlet.

11. The method according to claim 9, wherein the at least one physical parameter comprises a difference between a temperature of the air stream at an air inlet of the second heat exchanger and a temperature at an air outlet of the second heat exchanger.

12. The method according to claim 9, wherein the at least one physical parameter comprises an electrical impedance of laundry within the drum.

13. The method according to claim 9, wherein the at least one physical parameter comprises a temperature of a refrigerant in a refrigerant outlet of the second heat exchanger.

14. The method according to claim 13, wherein the reduction of rotation speed of the compressor is performed after a delay time interval has elapsed from the detection of a maximum temperature value of the refrigerant.

15. The method according to claim 9, wherein the at least one physical parameter comprises a relative humidity of drying air within the drum.
